(19) United States
(12) Patent Application Publication
(10) Pub. No.: US 2023/0325990 A1
(43) Pub. Date: Oct. 12, 2023

(54) TONE MAPPING USING GRADIENT DESCENT

(71) Applicant: GoPro, Inc., San Mateo, CA (US)

(72) Inventors: Violaine Marie Mong-lan Sudret, Paris (FR); Téo Marcin, Colombes (FR)

(21) Appl. No.: 17/715,674

(22) Filed: Apr. 7, 2022

(51) Int. Cl. G06T 5/40; G06T 5/00; H04N 5/235

(52) U.S. Cl. CPC G06T 5/40; G06T 5/009; H04N 5/2355; G06T 2207/20208

(57) ABSTRACT

A computer accesses a luminance histogram of an image. The computer determines a target histogram for the image based on a mean luminance of the image and based on a high dynamic range or a low dynamic range status of the image. The computer determines a first loss function based on a sum of a second loss function and a third loss function, the second loss function corresponding to a difference between the luminance histogram and the target histogram, the third loss function corresponding to a difference between a mean luminance of the image and a mean luminance target. The computer computes a gradient descent result by applying a gradient descent algorithm to the first loss function using a tuning constant based on image quality constraints and an exposure target. The computer generates a tone curve comprising the computed gradient descent result.

### TECHNICAL FIELD

This disclosure relates to an image capture device or a server that performs tone mapping and a method and apparatus for tone mapping using gradient descent.

### BACKGROUND

An image capture device may capture an image that has a limited dynamic range. Tone mapping may be used to preserve image details while increasing image contrast. Techniques for tone mapping may be desirable.

### SUMMARY

The present teachings provide a method that includes accessing, by a computing device, a luminance histogram of an image. The method includes determining, from a predefined set of target histograms, a target histogram for the image based on a mean luminance of the image and based on a high dynamic range (HDR) or a low dynamic range (LDR) status of the image. The method includes determining a first loss function based on a sum of a second loss function and a third loss function, the second loss function corresponding to a difference between the luminance histogram and the target histogram, the third loss function corresponding to a difference between a mean luminance of the image and a mean luminance target. The method includes computing a gradient descent result by applying a gradient descent algorithm to the first loss function using a tuning constant based on image quality constraints and an exposure target. The method includes generating, at the computing device, a tone curve comprising the computed gradient descent result.

The present teachings provide an apparatus that includes processing circuitry and a memory storing instructions which, when executed by the processing circuitry, cause the processing circuitry to perform operations. The operations include determining a luminance histogram of an image based on luminance values for pixels of the image. The operations include determining a target histogram for the image based on a mean luminance of the image. The operations include determining a first loss function based on a sum of a second loss function and a third loss function, the second loss function corresponding to a difference between the luminance histogram and the target histogram, the third loss function corresponding to a difference between a mean luminance of the image and a mean luminance target. The operations include computing a gradient descent result by applying a gradient descent algorithm to the first loss function using a tuning constant based on image quality constraints and an exposure target. The operations include generating a tone curve comprising the computed gradient descent result. The operations include providing for display of the tone curve.

The present teachings provide a machine-readable medium storing instructions that, when executed by processing circuitry, cause the processing circuitry to perform operations. The operations include obtaining an image via an image sensor. The operations include generating a luminance histogram of the image. The operations include identifying a target histogram for the image. The operations include determining a first loss function based on a sum of a second loss function and a third loss function, the second loss function corresponding to a difference between the luminance histogram and the target histogram, the third loss function corresponding to a difference between a mean luminance of the image and a mean luminance target. The operations include computing a gradient descent result by applying a gradient descent algorithm to the first loss function using a tuning constant based on image quality constraints and an exposure target. The operations include generating a tone curve comprising the computed gradient descent result.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-B are isometric views of an example of an image capture device.

FIGS. 2A-B are isometric views of another example of an image capture device.

FIG. 2C is a top view of the image capture device of FIGS. 2A-B.

FIG. 2D is a partial cross-sectional view of the image capture device of FIG. 2C.

FIG. 3 is a block diagram of electronic components of an image capture device.

FIG. 4A-C are block diagrams of examples of systems for tone mapping using gradient descent.

FIG. 5 is a block diagram of an example of a computing device for tone mapping using gradient descent.

FIG. 6 is a flow chart of a method of tone mapping using gradient descent.

### DETAILED DESCRIPTION

The present teachings provide a computing device that implements tone mapping using gradient descent. The computing device may include an image capture device and/or a server. The computing device accesses a luminance histogram of an image. The computing device determines, from a predefined set of target histograms, a target histogram for the image based on a mean luminance of the image and based on a high dynamic range (HDR) or a low dynamic range (LDR) status of the image. The computing device determines a first loss function based on a sum of a second loss function and a third loss function. The second loss function corresponds to a difference between the luminance histogram and the target histogram. The third loss function corresponds to a difference between a mean luminance of the image and a mean luminance target. The computing device computes a gradient descent result by applying a gradient descent algorithm to the first loss function using a tuning constant based on image quality constraints and an exposure target. The computing device generates a tone curve including the computed gradient descent result.

The tone curve may be a look up table based on the computed gradient descent result. The tone curve may be applied on the image to generate, by the computing device, a modified tone map image. Some implementations allow the computing device to generate the modified tone map image, which may preserve image details of the original image while increasing image contrast relative to that of the original image. As a result, higher quality modified tone map image(s) may be generated by the computing device, resulting in greater appreciation of the higher quality images by the user of the computing device and others who access the generated modified tone map image(s).

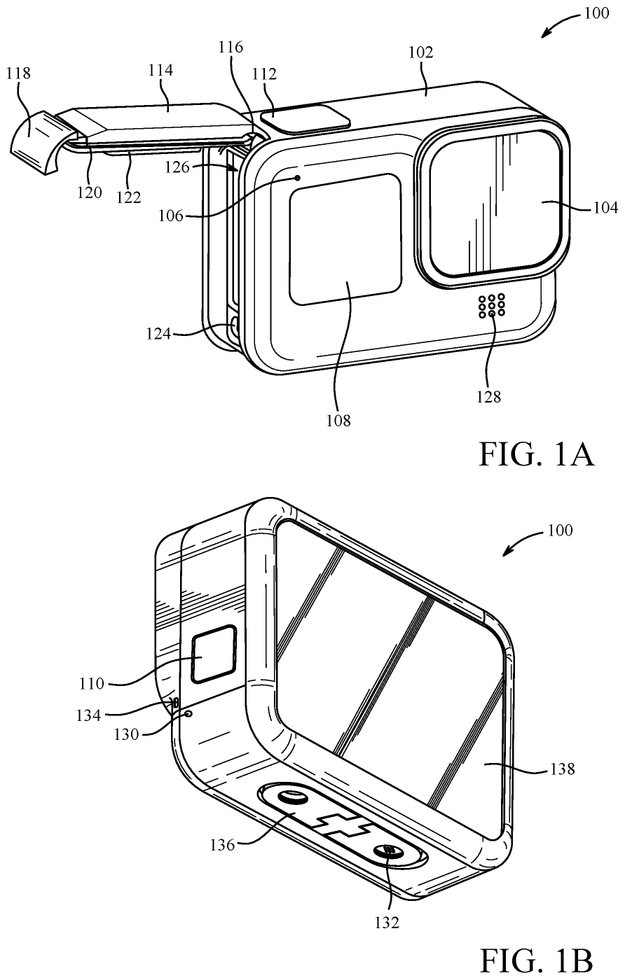

FIGS. 1A-B are isometric views of an example of an image capture device 100. The image capture device 100 may include a body 102, a lens 104 structured on a front surface of the body 102, various indicators on the front surface of the body 102 (such as light-emitting diodes (LEDs), displays, and the like), various input mechanisms (such as buttons, switches, and/or touch-screens), and electronics (such as imaging electronics, power electronics, etc.) internal to the body 102 for capturing images via the lens 104 and/or performing other functions. The lens 104 is configured to receive light incident upon the lens 104 and to direct received light onto an image sensor internal to the body 102. The image capture device 100 may be configured to capture images and video and to store captured images and video for subsequent display or playback.

The image capture device 100 may include an LED or another form of indicator 106 to indicate a status of the image capture device 100 and a liquid-crystal display (LCD) or other form of a display 108 to show status information such as battery life, camera mode, elapsed time, and the like. The image capture device 100 may also include a mode button 110 and a shutter button 112 that are configured to allow a user of the image capture device 100 to interact with the image capture device 100. For example, the mode button 110 and the shutter button 112 may be used to turn the image capture device 100 on and off, scroll through modes and settings, and select modes and change settings. The image capture device 100 may include additional buttons or interfaces (not shown) to support and/or control additional functionality.

The image capture device 100 may include a door 114 coupled to the body 102, for example, using a hinge mechanism 116. The door 114 may be secured to the body 102 using a latch mechanism 118 that releasably engages the body 102 at a position generally opposite the hinge mechanism 116. The door 114 may also include a seal 120 and a battery interface 122. When the door 114 is an open position, access is provided to an input-output (I/O) interface 124 for connecting to or communicating with external devices as described below and to a battery receptacle 126 for placement and replacement of a battery (not shown). The battery receptacle 126 includes operative connections (not shown) for power transfer between the battery and the image capture device 100. When the door 114 is in a closed position, the seal 120 engages a flange (not shown) or other interface to provide an environmental seal, and the battery interface 122 engages the battery to secure the battery in the battery receptacle 126. The door 114 can also have a removed position (not shown) where the entire door 114 is separated from the image capture device 100, that is, where both the hinge mechanism 116 and the latch mechanism 118 are decoupled from the body 102 to allow the door 114 to be removed from the image capture device 100.

The image capture device 100 may include a microphone 128 on a front surface and another microphone 130 on a side surface. The image capture device 100 may include other microphones on other surfaces (not shown). The microphones 128, 130 may be configured to receive and record audio signals in conjunction with recording video or separate from recording of video. The image capture device 100 may include a speaker 132 on a bottom surface of the image capture device 100. The image capture device 100 may include other speakers on other surfaces (not shown). The speaker 132 may be configured to play back recorded audio or emit sounds associated with notifications.

A front surface of the image capture device 100 may include a drainage channel 134. A bottom surface of the image capture device 100 may include an interconnect mechanism 136 for connecting the image capture device 100 to a handle grip or other securing device. In the example shown in FIG. 1B, the interconnect mechanism 136 includes folding protrusions configured to move between a nested or collapsed position as shown and an extended or open position (not shown) that facilitates coupling of the protrusions to mating protrusions of other devices such as handle grips, mounts, clips, or like devices.

The image capture device 100 may include an interactive display 138 that allows for interaction with the image capture device 100 while simultaneously displaying information on a surface of the image capture device 100.

The image capture device 100 of FIGS. 1A-B includes an exterior that encompasses and protects internal electronics. In the present example, the exterior includes six surfaces (i.e. a front face, a left face, a right face, a back face, a top face, and a bottom face) that form a rectangular cuboid. Furthermore, both the front and rear surfaces of the image capture device 100 are rectangular. In other embodiments, the exterior may have a different shape. The image capture device 100 may be made of a rigid material such as plastic, aluminum, steel, or fiberglass. The image capture device 100 may include features other than those described here. For example, the image capture device 100 may include additional buttons or different interface features, such as interchangeable lenses, cold shoes, and hot shoes that can add functional features to the image capture device 100.

The image capture device 100 may include various types of image sensors, such as charge-coupled device (CCD) sensors, active pixel sensors (APS), complementary metal-oxide-semiconductor (CMOS) sensors, N-type metal-oxide-semiconductor (NMOS) sensors, and/or any other image sensor or combination of image sensors.

Although not illustrated, in various embodiments, the image capture device 100 may include other additional electrical components (e.g., an image processor, camera system-on-chip (SoC), etc.), which may be included on one or more circuit boards within the body 102 of the image capture device 100.

The image capture device 100 may interface with or communicate with an external device, such as an external user interface device (not shown), via a wired or wireless computing communication link (e.g., the I/O interface 124). Any number of computing communication links may be used. The computing communication link may be a direct computing communication link or an indirect computing communication link, such as a link including another device or a network, such as the internet, may be used.

In some implementations, the computing communication link may be a Wi-Fi link, an infrared link, a Bluetooth (BT) link, a cellular link, a ZigBee link, a near field communications (NFC) link, such as an ISO/IEC 20643 protocol link, an Advanced Network Technology interoperability (ANT+) link, and/or any other wireless communications link or combination of links.

In some implementations, the computing communication link may be an HDMI link, a USB link, a digital video interface link, a display port interface link, such as a Video Electronics Standards Association (VESA) digital display interface link, an Ethernet link, a Thunderbolt link, and/or other wired computing communication link.

The image capture device 100 may transmit images, such as panoramic images, or portions thereof, to the external user interface device via the computing communication link, and the external user interface device may store, process, display, or a combination thereof the panoramic images.

The external user interface device may be a computing device, such as a smartphone, a tablet computer, a phablet, a smart watch, a portable computer, personal computing device, and/or another device or combination of devices configured to receive user input, communicate information with the image capture device 100 via the computing communication link, or receive user input and communicate information with the image capture device 100 via the computing communication link.

The external user interface device may display, or otherwise present, content, such as images or video, acquired by the image capture device 100. For example, a display of the external user interface device may be a viewport into the three-dimensional space represented by the panoramic images or video captured or created by the image capture device 100.

The external user interface device may communicate information, such as metadata, to the image capture device 100. For example, the external user interface device may send orientation information of the external user interface device with respect to a defined coordinate system to the image capture device 100, such that the image capture device 100 may determine an orientation of the external user interface device relative to the image capture device 100.

Based on the determined orientation, the image capture device 100 may identify a portion of the panoramic images or video captured by the image capture device 100 for the image capture device 100 to send to the external user interface device for presentation as the viewport. In some implementations, based on the determined orientation, the image capture device 100 may determine the location of the external user interface device and/or the dimensions for viewing of a portion of the panoramic images or video.

The external user interface device may implement or execute one or more applications to manage or control the image capture device 100. For example, the external user interface device may include an application for controlling camera configuration, video acquisition, video display, or any other configurable or controllable aspect of the image capture device 100.

The user interface device, such as via an application, may generate and share, such as via a cloud-based or social media service, one or more images, or short video clips, such as in response to user input. In some implementations, the external user interface device, such as via an application, may remotely control the image capture device 100 such as in response to user input.

The external user interface device, such as via an application, may display unprocessed or minimally processed images or video captured by the image capture device 100 contemporaneously with capturing the images or video by the image capture device 100, such as for shot framing or live preview, and which may be performed in response to user input. In some implementations, the external user interface device, such as via an application, may mark one or more key moments contemporaneously with capturing the images or video by the image capture device 100, such as with a tag or highlight in response to a user input or user gesture.

The external user interface device, such as via an application, may display or otherwise present marks or tags associated with images or video, such as in response to user input. For example, marks may be presented in a camera roll application for location review and/or playback of video highlights.

The external user interface device, such as via an application, may wirelessly control camera software, hardware, or both. For example, the external user interface device may include a web-based graphical interface accessible by a user for selecting a live or previously recorded video stream from the image capture device 100 for display on the external user interface device.

The external user interface device may receive information indicating a user setting, such as an image resolution setting (e.g., 3840 pixels by 2160 pixels), a frame rate setting (e.g., 60 frames per second (fps)), a location setting, and/or a context setting, which may indicate an activity, such as mountain biking, in response to user input, and may communicate the settings, or related information, to the image capture device 100.

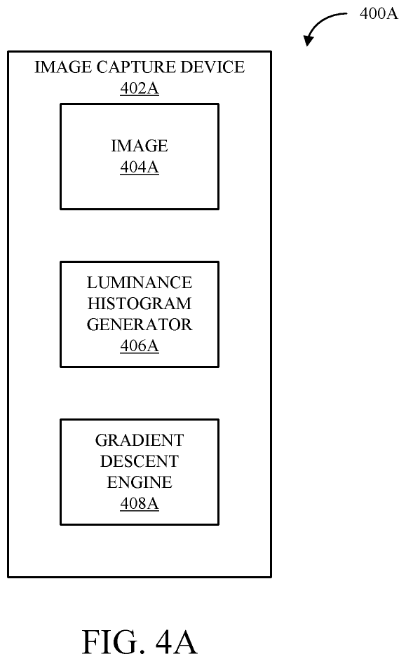

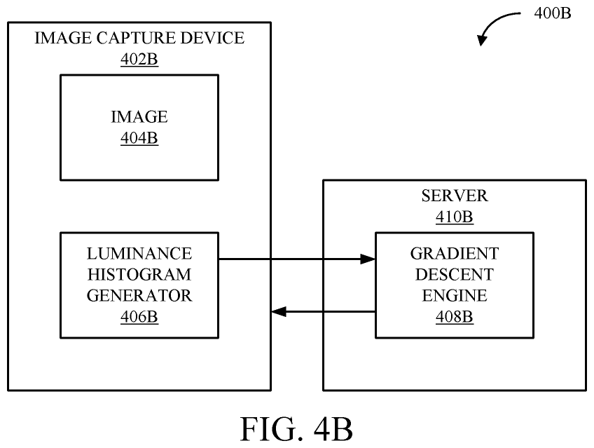

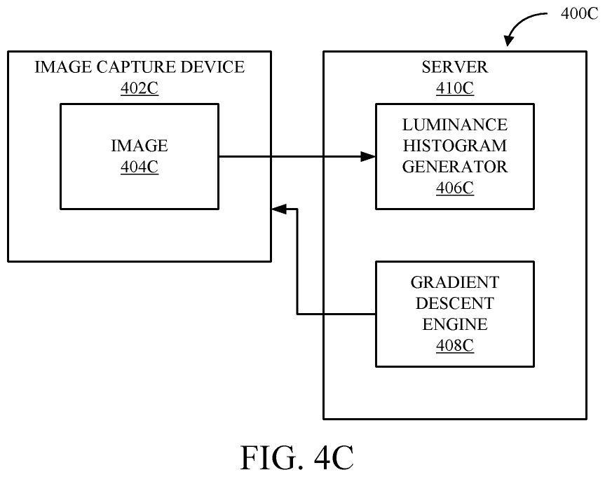

The image capture device 100 may be used to implement some or all of the techniques described in this disclosure, such as the technique of sound removal shown and described in FIGS. 4-8.

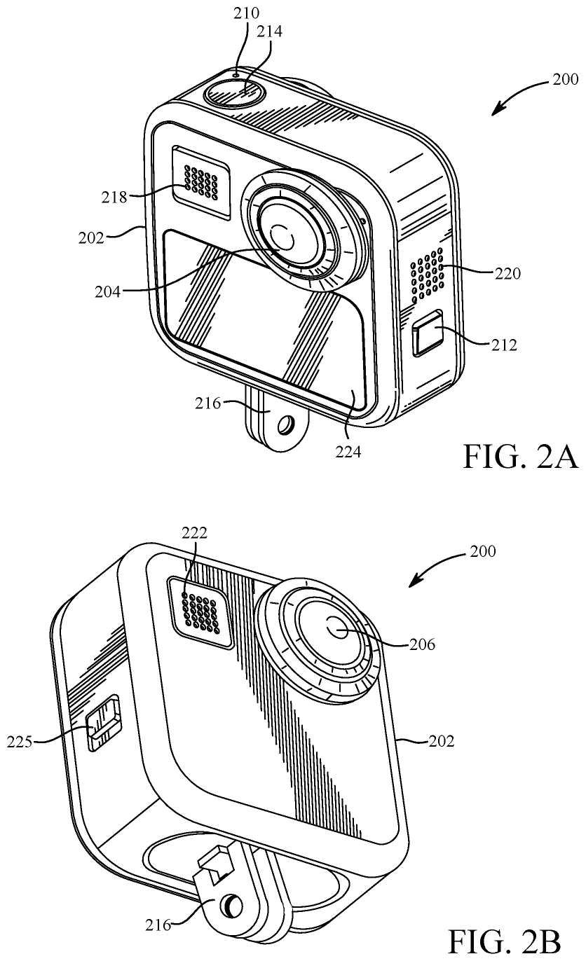

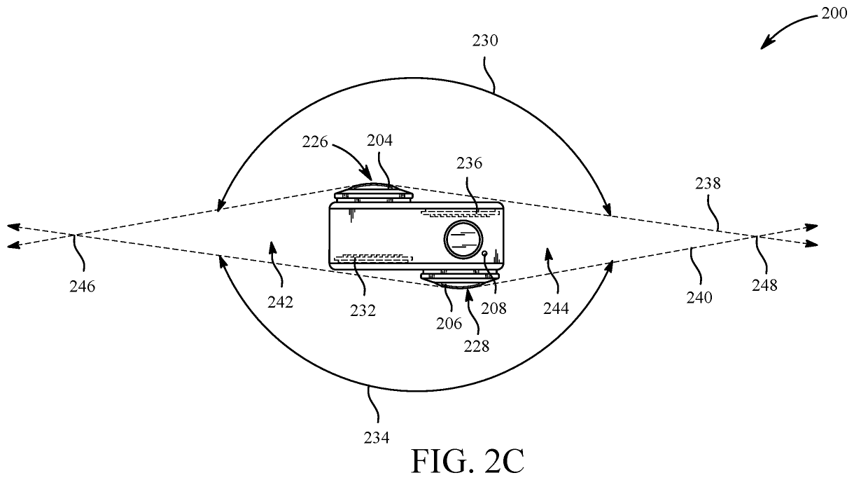

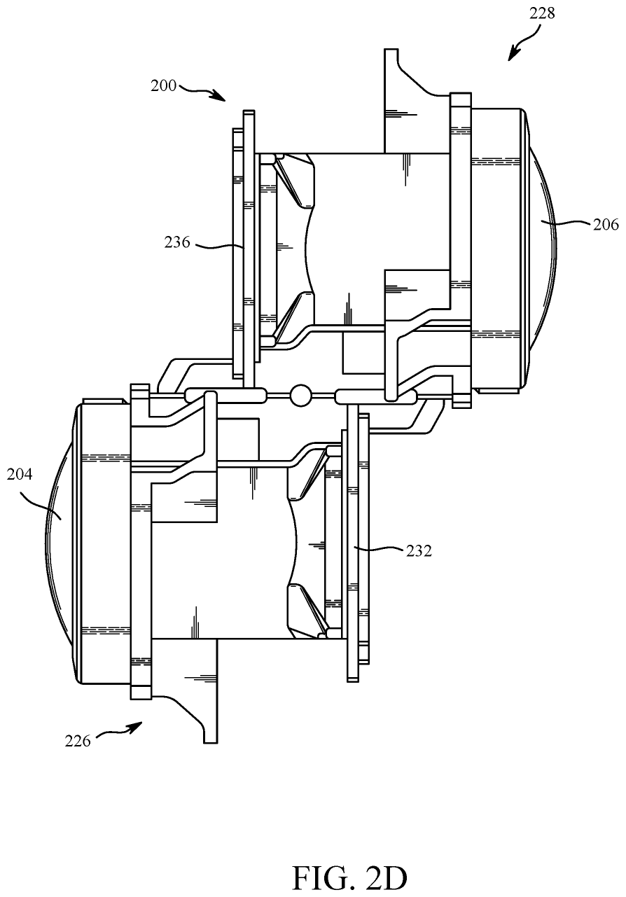

FIGS. 2A-B illustrate another example of an image capture device 200. The image capture device 200 includes a body 202 and two camera lenses 204 and 206 disposed on opposing surfaces of the body 202, for example, in a back-to-back configuration, Janus configuration, or offset Janus configuration. The body 202 of the image capture device 200 may be made of a rigid material such as plastic, aluminum, steel, or fiberglass.

The image capture device 200 includes various indicators on the front of the surface of the body 202 (such as LEDs, displays, and the like), various input mechanisms (such as buttons, switches, and touch-screen mechanisms), and electronics (e.g., imaging electronics, power electronics, etc.) internal to the body 202 that are configured to support image capture via the two camera lenses 204 and 206 and/or perform other imaging functions.

The image capture device 200 includes various indicators, for example, LEDs 208, 210 to indicate a status of the image capture device 100. The image capture device 200 may include a mode button 212 and a shutter button 214 configured to allow a user of the image capture device 200 to interact with the image capture device 200, to turn the image capture device 200 on, and to otherwise configure the operating mode of the image capture device 200. It should be appreciated, however, that, in alternate embodiments, the image capture device 200 may include additional buttons or inputs to support and/or control additional functionality.

The image capture device 200 may include an interconnect mechanism 216 for connecting the image capture device 200 to a handle grip or other securing device. In the example shown in FIGS. 2A and 2B, the interconnect mechanism 216 includes folding protrusions configured to move between a nested or collapsed position (not shown) and an extended or open position as shown that facilitates coupling of the protrusions to mating protrusions of other devices such as handle grips, mounts, clips, or like devices.

The image capture device 200 may include audio components 218, 220, 222 such as microphones configured to receive and record audio signals (e.g., voice or other audio commands) in conjunction with recording video. The audio component 218, 220, 222 can also be configured to play back audio signals or provide notifications or alerts, for example, using speakers. Placement of the audio components 218, 220, 222 may be on one or more of several surfaces of the image capture device 200. In the example of FIGS. 2A and 2B, the image capture device 200 includes three audio components 218, 220, 222, with the audio component 218 on a front surface, the audio component 220 on a side surface, and the audio component 222 on a back surface of the image capture device 200. Other numbers and configurations for the audio components are also possible.

The image capture device 200 may include an interactive display 224 that allows for interaction with the image capture device 200 while simultaneously displaying information on a surface of the image capture device 200. The interactive display 224 may include an I/O interface, receive touch inputs, display image information during video capture, and/or provide status information to a user. The status information provided by the interactive display 224 may include battery power level, memory card capacity, time elapsed for a recorded video, etc.

The image capture device 200 may include a release mechanism 225 that receives a user input to in order to change a position of a door (not shown) of the image capture device 200. The release mechanism 225 may be used to open the door (not shown) in order to access a battery, a battery receptacle, an I/O interface, a memory card interface, etc. (not shown) that are similar to components described in respect to the image capture device 100 of FIGS. 1A and 1B.

In some embodiments, the image capture device 200 described herein includes features other than those described. For example, instead of the I/O interface and the interactive display 224, the image capture device 200 may include additional interfaces or different interface features. For example, the image capture device 200 may include additional buttons or different interface features, such as interchangeable lenses, cold shoes, and hot shoes that can add functional features to the image capture device 200.

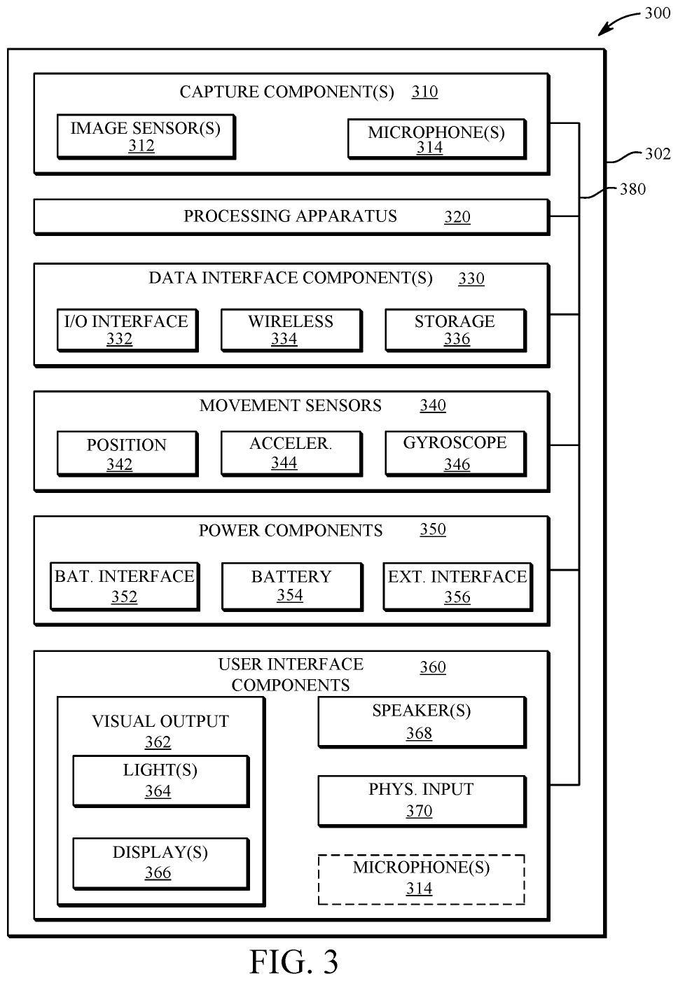

FIG. 3 is a block diagram of electronic components in an image capture device 300. The image capture device 300 may be a single-lens image capture device, a multi-lens image capture device, or variations thereof, including an image capture device with multiple capabilities such as use of interchangeable integrated sensor lens assemblies. The description of the image capture device 300 is also applicable to the image capture devices 100, 200 of FIGS. 1A-B and 2A-D.

The image capture device 300 includes a body 302 which includes electronic components such as capture components 310, a processing apparatus 320, data interface components 330, movement sensors 340, power components 350, and/or user interface components 360.

The capture components 310 include one or more image sensors 312 for capturing images and one or more microphones 314 for capturing audio.

The image sensor(s) 312 is configured to detect light of a certain spectrum (e.g., the visible spectrum or the infrared spectrum) and convey information constituting an image as electrical signals (e.g., analog or digital signals). The image sensor(s) 312 detects light incident through a lens coupled or connected to the body 302. The image sensor(s) 312 may be any suitable type of image sensor, such as a charge-coupled device (CCD) sensor, active pixel sensor (APS), complementary metal-oxide-semiconductor (CMOS) sensor, N-type metal-oxide-semiconductor (NMOS) sensor, and/or any other image sensor or combination of image sensors. Image signals from the image sensor(s) 312 may be passed to other electronic components of the image capture device 300 via a bus 380, such as to the processing apparatus 320. In some implementations, the image sensor(s) 312 includes a digital-to-analog converter. A multi-lens variation of the image capture device 300 can include multiple image sensors 312.

The microphone(s) 314 is configured to detect sound, which may be recorded in conjunction with capturing images to form a video. The microphone(s) 314 may also detect sound in order to receive audible commands to control the image capture device 300.

The processing apparatus 320 may be configured to perform image signal processing (e.g., filtering, tone mapping, stitching, and/or encoding) to generate output images based on image data from the image sensor(s) 312. The processing apparatus 320 may include one or more processors having single or multiple processing cores. In some implementations, the processing apparatus 320 may include an application specific integrated circuit (ASIC). For example, the processing apparatus 320 may include a custom image signal processor. The processing apparatus 320 may exchange data (e.g., image data) with other components of the image capture device 300, such as the image sensor(s) 312, via the bus 380.

The processing apparatus 320 may include memory, such as a random-access memory (RAM) device, flash memory, or another suitable type of storage device, such as a non-transitory computer-readable memory. The memory of the processing apparatus 320 may include executable instructions and data that can be accessed by one or more processors of the processing apparatus 320. For example, the processing apparatus 320 may include one or more dynamic random-access memory (DRAM) modules, such as double data rate synchronous dynamic random-access memory (DDR SDRAM). In some implementations, the processing apparatus 320 may include a digital signal processor (DSP). More than one processing apparatus may also be present or associated with the image capture device 300.

The data interface components 330 enable communication between the image capture device 300 and other electronic devices, such as a remote control, a smartphone, a tablet computer, a laptop computer, a desktop computer, or a storage device. For example, the data interface components 330 may be used to receive commands to operate the image capture device 300, transfer image data to other electronic devices, and/or transfer other signals or information to and from the image capture device 300. The data interface components 330 may be configured for wired and/or wireless communication. For example, the data interface components 330 may include an I/O interface 332 that provides wired communication for the image capture device, which may be a USB interface (e.g., USB type-C), a high-definition multimedia interface (HDMI), or a FireWire interface. The data interface components 330 may include a wireless data interface 334 that provides wireless communication for the image capture device 300, such as a Bluetooth interface, a ZigBee interface, and/or a Wi-Fi interface. The data interface components 330 may include a storage interface 336, such as a memory card slot configured to receive and operatively couple to a storage device (e.g., a memory card) for data transfer with the image capture device 300 (e.g., for storing captured images and/or recorded audio and video).

The movement sensors 340 may detect the position and movement of the image capture device 300. The movement sensors 340 may include a position sensor 342, an accelerometer 344, or a gyroscope 346. The position sensor 342, such as a global positioning system (GPS) sensor, is used to determine a position of the image capture device 300. The accelerometer 344, such as a three-axis accelerometer, measures linear motion (e.g., linear acceleration) of the image capture device 300. The gyroscope 346, such as a three-axis gyroscope, measures rotational motion (e.g., rate of rotation) of the image capture device 300. Other types of movement sensors 340 may also be present or associated with the image capture device 300.

The power components 350 may receive, store, and/or provide power for operating the image capture device 300. The power components 350 may include a battery interface 352 and a battery 354. The battery interface 352 operatively couples to the battery 354, for example, with conductive contacts to transfer power from the battery 354 to the other electronic components of the image capture device 300. The power components 350 may also include an external interface 356, and the power components 350 may, via the external interface 356, receive power from an external source, such as a wall plug or external battery, for operating the image capture device 300 and/or charging the battery 354 of the image capture device 300. In some implementations, the external interface 356 may be the I/O interface 332. In such an implementation, the I/O interface 332 may enable the power components 350 to receive power from an external source over a wired data interface component (e.g., a USB type-C cable).

The user interface components 360 may allow the user to interact with the image capture device 300, for example, providing outputs to the user and receiving inputs from the user. The user interface components 360 may include visual output components 362 to visually communicate information and/or present captured images to the user. The visual output components 362 may include one or more lights 364 and/or more displays 366. The display(s) 366 may be configured as a touch screen that receives inputs from the user. The user interface components 360 may also include one or more speakers 368. The speaker(s) 368 can function as an audio output component that audibly communicates information and/or presents recorded audio to the user. The user interface components 360 may also include one or more physical input interfaces 370 that are physically manipulated by the user to provide input to the image capture device 300. The physical input interfaces 370 may, for example, be configured as buttons, toggles, or switches. The user interface components 360 may also be considered to include the microphone(s) 314, as indicated in dotted line, and the microphone(s) 314 may function to receive audio inputs from the user, such as voice commands.

The image capture device 300 may be used to implement some or all of the techniques described in this disclosure, such as the techniques described in FIGS. 4-6.

FIG. 4A-C are block diagrams of examples of systems 400A, 400B, 400C for tone mapping using gradient descent.

FIG. 4A illustrates a first system 400A for tone mapping using gradient descent. As shown, the system 400A includes an image capture device 402A. The image capture device 402A may correspond to the image capture device 100, 200, or 300. As shown, the image capture device 402A stores an image 404A, a luminance histogram generator 406A, and a gradient descent engine 408A. The gradient descent engine 408A may compute the tone curve, which includes the gradient descent result. The image capture device 402A generates the image 404A, for example, using capture component(s) 310. The image 402A may be stored in the storage 336. The luminance histogram generator 406A may be software code (e.g., stored in the storage 336) and/or hardware (e.g., hard-wired into the processing apparatus 320). The computation of the tone curve, by the gradient descent engine 408A, may be performed using software code and/or hardware. The application of the tone curve may be performed using software code and/or hardware.

The luminance histogram generator 406A generates a luminance histogram of the image 404A and provides the generated luminance histogram to the gradient descent engine 408A. In some implementations, the luminance histogram generator 406A determines the luminance histogram of the image 404A by determining luminance values for pixels of the image 404A and determines the luminance histogram based on the luminance values. The luminance values may be determined based on a greyscale version of the image 404A.

The gradient descent engine 408A determines, from a predefined set of target histograms, a target histogram for the image 404A based on a mean luminance of the image 404A and based on an HDR or a LDR status of the image 404A. The predefined set of target histograms may be stored in the storage 336 and/or in a data repository (e.g., a server or a database) external to the image capture device 402A and accessible to the image capture device 402A via a network. The mean luminance may be computed based on the luminance histogram to simplify the calculation.

The gradient descent engine 408A determines a first loss function based on a sum of a second loss function and a third loss function. The second loss function corresponds to a difference between the luminance histogram (generated by the luminance histogram generator 406A) and the target histogram. The third loss function corresponds to a difference between a mean luminance of the image and a mean luminance target. The gradient descent engine 408A computes a gradient descent result by applying a gradient descent algorithm to the first loss function using a tuning constant based on image quality constraints and an exposure target. For example, the gradient descent engine 408A may minimize the first loss function while maintaining preset constraints (e.g., avoiding noise enhancement above a noise enhancement threshold level, avoiding crushing black pixels above a black threshold level, or avoiding saturating or desaturating white pixels above a white threshold level). The gradient descent engine 408A generates a tone curve comprising the computed gradient descent result. As shown, the gradient descent engine 408A is part of the image capture device 402A. The image capture device 402A may include or be connected (e.g., using a wired connection or a wireless connection) to display(s) 366. The tone curve and/or a modified tone map image (based on the tone curve) may be displayed via the display(s) 366.

FIG. 4B illustrates a second system 400B for tone mapping using gradient descent. The system 400B is similar to the system 400A. The image capture device 402B may correspond to the image capture device 100, 200, 300, or 402A. The image 404B may correspond to the image 404A. The luminance histogram generator 406B functions similarly to the luminance histogram generator 406A. The gradient descent engine 408B functions similarly to the gradient descent engine 408A. However, the gradient descent engine 408B resides at a server 410B rather than at the image capture device 402B. The gradient descent engine 408B at the server 410B receives the luminance histogram from the luminance histogram generator 406B at the image capture device 402B. The image capture device 402B transmits the luminance histogram to the server 410B. The gradient descent engine 408B (which is separate from the computation of gradient descent) generates the tone curve using the technique described herein and provides the generated tone curve to the image capture device 402B for display and/or storage thereat. The image capture device 402B and the server 410B may communicate with one another over a network. As shown, the gradient descent engine 408B resides on the server 410B. In alternative implementations, the gradient descent engine 408B may reside at the image capture device.

FIG. 4C illustrates a third system 400C for tone mapping using gradient descent. The system 400C is similar to the systems 400A and 400B and includes similar components—the image capture device 402C, the image 404C, the luminance histogram generator 406C, the gradient descent engine 408C, and the server 410C. In the system 400C, the image 404C resides at the image capture device 402C and is transmitted to the server 410C. The luminance histogram generator 406C and the gradient descent engine 408C reside at the server 410C.

According to some implementations, as shown in FIG. 4C, the image capture device 402C transmits the image 404C to the luminance histogram generator 406C at the server 410C for generation of the luminance histogram at the server 410C. The server 410C receives the image from the image capture device 402C. The generated luminance histogram is provided to the gradient descent engine 408C at the server 410C. The gradient descent engine 408C generates the tone curve and provides the generated tone curve to the image capture device 402B for display and/or storage thereat. The image capture device 402C and the server 410C may communicate with one another over a network.

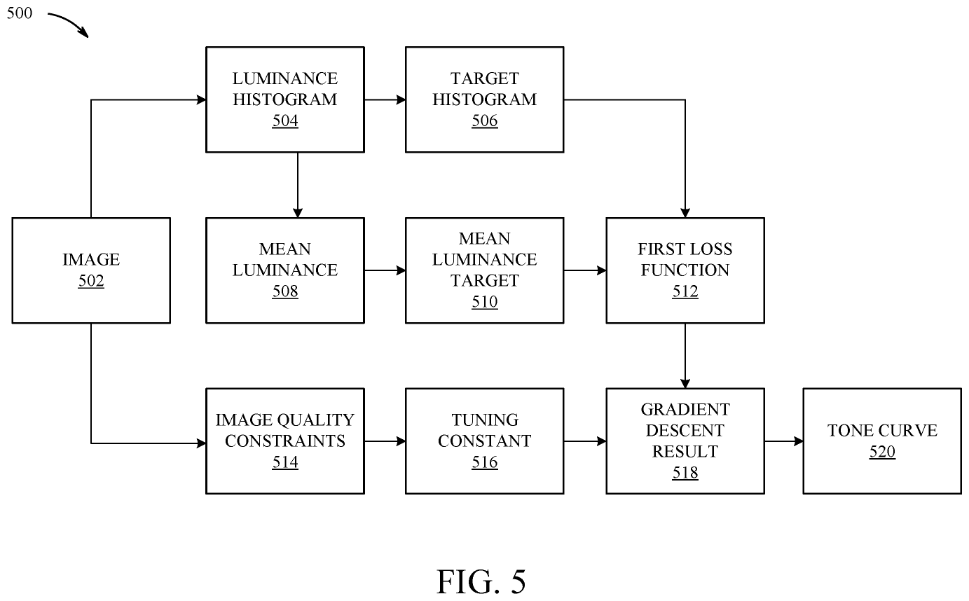

FIG. 5 is a block diagram of an example of a computing device 500 for tone mapping using gradient descent. The computing device 500 may correspond to at least one or a combination of the image capture devices 100, 200, 300, 402A, 402B, 402C or the servers 410B, 410C. While a single computing device 500 is illustrated in FIG. 5, the illustrated computing device 500 may correspond to multiple computing devices working together, each of which may implement all or a portion of the components of the computing device 500.

As shown, the computing device 500 stores an image 502. The image may be generated via an image capture device such as the image capture devices 100, 200, 300, 402A, 402B, 402C that is internal or external to the computing device 500. The computing device 500 generates a luminance histogram 504 of the image 502 based on luminance values for pixels of the image 502. The luminance histogram 504 is compared with a target histogram 506 for the image 502. The computing device 500 computes a mean luminance 508 using the luminance histogram 504 and accesses a mean luminance target 510. Computing the mean luminance 508 using the luminance histogram 504 reduces the complexity of the computations. The computing device 500 computes a first loss function 512 based on the mean luminance 508, the mean luminance target 510, the luminance histogram 504, and the target histogram 506. The computing device 500 accesses image quality constraints 514 for the image 502 to identify a tuning constant 516. The computing device 500 computes a gradient descent result 518 by applying a gradient descent algorithm to the first loss function 512 using the tuning constant 516. The computing device 500 generates a tone curve 520 including the gradient descent result 518. The tone curve 520 may be a look up table based on the computed gradient descent result. The tone curve 520 may be applied on the image to generate, by the computing device 500, a modified tone map image. The modified tone map image may be displayed and/or stored by the computing device 500.

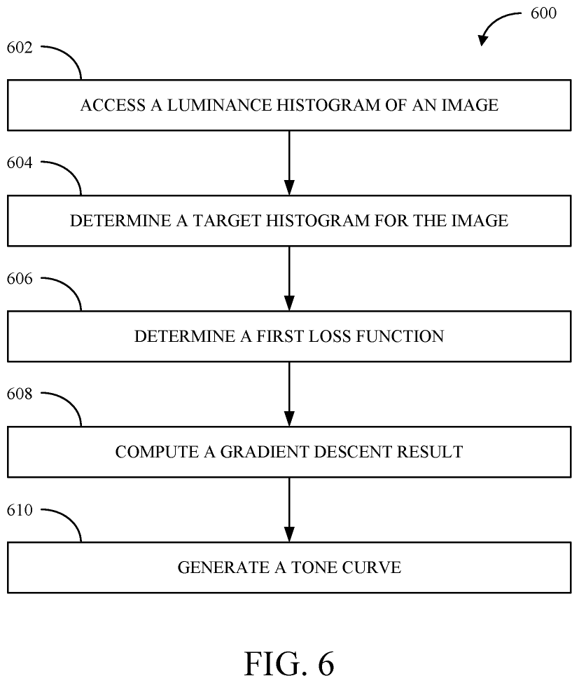

FIG. 6 is a flow chart of a method 600 of tone mapping using gradient descent. The method 600 may be implemented by a computing device, such as by the computing device 500 or by at least one or a combination of the image capture devices 100, 200, 300, 402A, 402B, 402C or the servers 410B, 410C.

At block 602, the computing device accesses a luminance histogram (e.g., the luminance histogram 504) of an image (e.g., the image 502). The luminance histogram may be generated based on luminance values that are determined for pixels of the image, for example, using one of the luminance histogram generators 406A, 406B, or 406C. The luminance histogram may be generated at the computing device (e.g., as shown in FIG. 4A, with the computing device including the image capture device 402A, or as shown in FIG. 4C, with the computing device including the server 410C) or at a remote device external to the computing device (e.g., as shown in FIG. 4B, with the computing device including the server 410B and not the image capture device 402B). The luminance values may be determined based on a greyscale version of the image. In some implementations, the computing device obtains the image via an image sensor and automatically (e.g., without additional input or intentional delay) generates the luminance histogram in response to obtaining the image.

At block 604, the computing device determines, from a predefined set of target histograms, a target histogram for the image. The target histogram may be determined based on a mean luminance of the image and based on an HDR or a LDR status of the image. The predefined set of target histograms may be stored at the computing device and/or at a data repository (e.g., a database or other data storage unit) accessible to the computing device, for example, via a network.

At block 606, the computing device determines a first loss function based on a sum of a second loss function and a third loss function. The second loss function corresponds to a difference between the luminance histogram and the target histogram. The third loss function corresponds to a difference between a mean luminance of the image and a mean luminance target.

At block 608, the computing device computes a gradient descent result. The gradient descent result may be computed by applying a gradient descent algorithm to the first loss function using a tuning constant based on image quality constraints and an exposure target. The gradient descent result may be computed by minimizing the first loss function while maintaining preset constraints. The preset constraints may include at least one of: avoiding noise enhancement above a noise enhancement threshold level, avoiding crushing black pixels above a black threshold level, or avoiding saturating or desaturating white pixels above a white threshold level. As used herein, the phrase “crushing black pixels” may refer to the loss of fidelity in dark areas of an image (i.e., areas that are darker than a threshold darkness level). The term might be used to describe the loss of detail (e.g., shadow detail) in images, as darker parts of an image are illustrated as black rather than a dark shade of red, blue or some other color. The preset constraints may include maximal slopes and/or minimal slopes. The maximal slopes and/or minimal slopes may vary regarding the histogram bin. (Each histogram bin may have a different luminosity value.)

At block 610, the computing device generates a tone curve including the computed gradient descent result. The tone curve may be a look up table based on the computed gradient descent result. The tone curve may be applied on the image to generate, by the computing device, a modified tone map image. The computing device may display, via a display unit of the computing device, the modified tone map image. Alternatively, the computing device may transmit the generated modified tone map image to a remote device for display or storage thereat. The computing device may display all or part of the tone curve.

In some implementations, the computing device includes a camera (e.g., the image sensors 312) and a display unit (e.g., the display(s) 366). The computing device obtains the image via the camera, determines the luminance histogram of the image, and displays, via the display unit, the modified tone map image.

In some implementations, the computing device (e.g., the server 410B or 410C) receives the image and/or the luminance histogram of the image from a remote device (e.g., the image capture device 402B or 402C). The computing device transmits the modified tone map image to the remote device for display and/or storage thereat.

When saturated parts are taken into account in histogram equalization, multiple issues may arise. First, since a transfer function may be similar to a cumulative histogram of the image luminance, the saturated part of an image creates a peak in the transfer function leading to quantization and desaturation in images. Second, a peak at the end of the transfer function implies lower slopes for the rest of the transfer function (since it is similar to the normalized cumulative histogram). In some cases, these slopes are too low and create strong tone flattening.

Some implementations cause the transfer function to have an identity slope in the saturated part during the histogram equalization. The regularization should not change this slope (e.g., white pixels may be protected). Thus, the maximum and minimum slopes may be close to one in the saturated part. As a result, quantization, saturation, desaturation, and strong tone flattening issues may be solved.

Some implementations may lead to losing black pixels due to strong enhancement on one hand and crushing black pixels due to a too low slope for black pixels on the other hand. Limiting the maximal and minimal slope in the darkest area allows for protection of the black pixels.

Slopes that are too large or too small lead to artifacts like noise, unnatural effect, or tone flattening. Thus, the gradient descent limits the slopes. However, these restrictions might not lead to an un-contrasted image or areas of the image and might be as close as possible to the initial curve while avoiding extreme slopes. Moreover, this gradient descent may keep the global luminance at a level that maintains a sufficient exposure on images and to avoids undesirable exposure changes in videos. In some cases, this gradient descent may allow maximum and minimum slopes that depend on luminance in order to allow white and black protection, but also customized slopes following a noise model.

One solution is to find a transfer function (e.g., an optimal transfer function) that respects all of the constraints. This can be seen as an optimization under constraints problem as shown in Equation 1. This may be written as a minimization problem shown in Equation 2.

Minimize loss=loss_target+loss_lum where loss_target=d(tf_init,tf_final) and loss_lum=d(mean_global_luma_target,mean_global_luma_final) Equation 1

Minimize loss=loss_thmax+loss_thmin+loss_target+loss_lum where loss_thmax=∥max(tf′−thMax,0)∥₂² and loss_thmin=∥max(thMin−tf′,0)∥₂² Equation 2

Some implementations may minimize a loss function that takes all the constraints into account. Each constraint may be associated to a loss function. Some implementations solve this problem with a gradient descent and set priorities to the constraints. Some implementations set coefficients to each loss function. According to some implementations, with grad_X=grad(loss_X), it may be desirable to have grad_max≈grad min>>grad_target, grad_lum; grad_lum≈grad_target in still capture scenarios and grad_lum>grad_target in video capture scenarios.

Gradient descent optimization is expressed in Equation 3. To speed up the optimization process, some implementations add a momentum. Momentum includes a mechanism that causes the gradient to keep its direction and its power (similar to momentum in physics). This is shown in Equations 4a-4b. To speed up the process, some implementations adapt the step size η according to the gradient power. Some implementations use an algorithm described in Equations 5a-5b.

tfₜ₊₁=tfₜ−η×∇loss(tfₜ) Equation 3

Δₜ=−(1−α)×η×∇loss(tfₜ)+αΔₜ₋₁ Equation 4a

tfₜ₊₁=tfₜ+Δₜ Equation 4b

gₜ=β*gₜ₋₁+(1−β)*(∇loss(tfₜ))² Equation 5a

tfₜ₊₁=tfₜ−∇loss(tfₜ)×[η/√(gₜ)] Equation 5b

In some implementations, a security mechanism is implemented to prevent oscillations around the solution. If the loss does not decrease after N iterations (e.g., N=500), the step size may be decreased (e.g., divided by two) in order to get closer to a solution (e.g., an optimal solution).

According to some implementations, when a higher coefficient is set for loss_lum (respect the luma constraint), the obtained curve may be farther from the initial curve but may respect as far as possible the luma constraint. This may be useful in video mode.

If grad_lum≈grad_target, which is useful in still mode, a compromise is found by the algorithm. Some examples lead to more natural results. In one example, if a regularization is used in the low lights because the initial slope is too strong, the gradient descent might boost highlights in order to achieve the luma constraint. Some parts of the dynamic range may be impacted strongly. In some examples, this may be solved by adding a new constraint to avoid changing the whole curve to tackle a local issue.

Some implementations are described below as numbered examples (Example 1, 2, 3, etc.). These examples are provided as examples only and do not limit the other implementations disclosed herein.

Example 1 is a method comprising: accessing, by a computing device, a luminance histogram of an image; determining, from a predefined set of target histograms, a target histogram for the image based on a mean luminance of the image and based on a high dynamic range (HDR) or a low dynamic range (LDR) status of the image; determining a first loss function based on a sum of a second loss function and a third loss function, the second loss function corresponding to a difference between the luminance histogram and the target histogram, the third loss function corresponding to a difference between a mean luminance of the image and a mean luminance target; computing a gradient descent result by applying a gradient descent algorithm to the first loss function using a tuning constant based on image quality constraints and an exposure target; and generating, at the computing device, a tone curve comprising the computed gradient descent result.

In Example 2, the subject matter of Example 1 includes, determining the luminance histogram of the image by: determining luminance values for pixels of the image; and determining the luminance histogram based on the luminance values.

In Example 3, the subject matter of Example 2 includes, wherein the luminance values are determined based on a greyscale version of the image.

In Example 4, the subject matter of Examples 1-3 includes, wherein computing the gradient descent comprises minimizing the first loss function while maintaining preset constraints.

In Example 5, the subject matter of Example 4 includes, wherein the preset constraints comprise at least one of: avoiding noise enhancement above a noise enhancement threshold level, avoiding crushing black pixels above a black threshold level, or avoiding saturating or desaturating white pixels above a white threshold level.

In Example 6, the subject matter of Examples 1-5 includes, wherein the computing device comprises a camera and a display unit, the method further comprising: obtaining the image via the camera of the computing device; determining the luminance histogram of the image; and displaying, via the display unit of the computing device, the tone curve.

In Example 7, the subject matter of Examples 1-6 includes, receiving the image or the luminance histogram of the image from a remote device; and transmitting the tone curve to the remote device.

Example 8 is an apparatus comprising: processing circuitry; and a memory storing instructions which, when executed by the processing circuitry, cause the processing circuitry to: determine a luminance histogram of an image based on luminance values for pixels of the image; determine a target histogram for the image based on a mean luminance of the image; determine a first loss function based on a sum of a second loss function and a third loss function, the second loss function corresponding to a difference between the luminance histogram and the target histogram, the third loss function corresponding to a difference between a mean luminance of the image and a mean luminance target; compute a gradient descent result by applying a gradient descent algorithm to the first loss function using a tuning constant based on image quality constraints and an exposure target; generate a tone curve comprising the computed gradient descent result; and provide for display of the tone curve.

In Example 9, the subject matter of Example 8 includes, wherein the luminance values are determined based on a greyscale version of the image.

In Example 10, the subject matter of Examples 8-9 includes, wherein computing the gradient descent comprises minimizing the first loss function while maintaining preset constraints.

In Example 11, the subject matter of Example 10 includes, wherein the preset constraints comprise at least one of: avoiding noise enhancement above a noise enhancement threshold level, avoiding crushing black pixels above a black threshold level, or avoiding saturating or desaturating white pixels above a white threshold level.

In Example 12, the subject matter of Examples 8-11 includes, a camera and a display unit, the memory further storing instructions which, when executed by the processing circuitry, cause the processing circuitry to: obtain the image via the camera; determine the luminance histogram of the image; and display, via the display unit, the tone curve.

In Example 13, the subject matter of Examples 8-12 includes, the memory further storing instructions which, when executed by the processing circuitry, cause the processing circuitry to: receive the image or the luminance histogram of the image from a remote device; and transmit the tone curve to the remote device.

Example 14 is a non-transitory machine-readable medium storing instructions that, when executed by processing circuitry, cause the processing circuitry to: obtain an image via an image sensor; generate a luminance histogram of the image; identify a target histogram for the image; determine a first loss function based on a sum of a second loss function and a third loss function, the second loss function corresponding to a difference between the luminance histogram and the target histogram, the third loss function corresponding to a difference between a mean luminance of the image and a mean luminance target; compute a gradient descent result by applying a gradient descent algorithm to the first loss function using a tuning constant based on image quality constraints and an exposure target; and generate a tone curve comprising the computed gradient descent result.

In Example 15, the subject matter of Example 14 includes, storing instructions which, when executed by the processing circuitry, cause the processing circuitry to: determine the luminance histogram of the image using instructions which, when executed by the processing circuitry, cause the processing circuitry to: determine luminance values for pixels of the image; and determine the luminance histogram based on the luminance values.

In Example 16, the subject matter of Example 15 includes, wherein the luminance values are determined based on a greyscale version of the image.

In Example 17, the subject matter of Examples 14-16 includes, wherein computing the gradient descent comprises minimizing the first loss function while maintaining preset constraints.

In Example 18, the subject matter of Example 17 includes, wherein the preset constraints comprise at least one of: avoiding noise enhancement above a noise enhancement threshold level, avoiding crushing black pixels above a black threshold level, or avoiding saturating or desaturating white pixels above a white threshold level.

In Example 19, the subject matter of Examples 14-18 includes, storing instructions which, when executed by the processing circuitry, cause the processing circuitry to: determine the luminance histogram of the image; and display the tone curve.

In Example 20, the subject matter of Examples 14-19 includes, wherein the luminance histogram is obtained automatically in response to obtaining the image via an image sensor.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method comprising:
accessing, by a computing device, a luminance histogram of an image;
determining, from a predefined set of target histograms, a target histogram for the image based on a mean luminance of the image and based on a high dynamic range (HDR) or a low dynamic range (LDR) status of the image;
determining a first loss function based on a sum of a second loss function and a third loss function, the second loss function corresponding to a difference between the luminance histogram and the target histogram, the third loss function corresponding to a difference between a mean luminance of the image and a mean luminance target;
computing a gradient descent result by applying a gradient descent algorithm to the first loss function using a tuning constant based on image quality constraints and an exposure target; and
generating, at the computing device, a tone curve comprising the computed gradient descent result.

2. The method of claim 1, further comprising:
determining the luminance histogram of the image by:
determining luminance values for pixels of the image; and
determining the luminance histogram based on the luminance values.

3. The method of claim 2, wherein the luminance values are determined based on a greyscale version of the image.

4. The method of claim 1, wherein computing the gradient descent comprises minimizing the first loss function while maintaining preset constraints.

5. The method of claim 4, wherein the preset constraints comprise at least one of: avoiding noise enhancement above a noise enhancement threshold level, avoiding crushing black pixels above a black threshold level, or avoiding saturating or desaturating white pixels above a white threshold level.

6. The method of claim 1, wherein the computing device comprises a camera and a display unit, the method further comprising:
obtaining the image via the camera of the computing device;
determining the luminance histogram of the image; and
displaying, via the display unit of the computing device, the tone curve.

7. The method of claim 1, further comprising:
receiving the image or the luminance histogram of the image from a remote device; and
transmitting the tone curve to the remote device.

8. An apparatus comprising:
processing circuitry; and
a memory storing instructions which, when executed by the processing circuitry, cause the processing circuitry to:
determine a luminance histogram of an image based on luminance values for pixels of the image;
determine a target histogram for the image based on a mean luminance of the image;
determine a first loss function based on a sum of a second loss function and a third loss function, the second loss function corresponding to a difference between the luminance histogram and the target histogram, the third loss function corresponding to a difference between a mean luminance of the image and a mean luminance target;
compute a gradient descent result by applying a gradient descent algorithm to the first loss function using a tuning constant based on image quality constraints and an exposure target;
generate a tone curve comprising the computed gradient descent result; and
provide for display of the tone curve.

9. The apparatus of claim 8, wherein the luminance values are determined based on a greyscale version of the image.

10. The apparatus of claim 8, wherein computing the gradient descent comprises minimizing the first loss function while maintaining preset constraints.

11. The apparatus of claim 10, wherein the preset constraints comprise at least one of: avoiding noise enhancement above a noise enhancement threshold level, avoiding crushing black pixels above a black threshold level, or avoiding saturating or desaturating white pixels above a white threshold level.

12. The apparatus of claim 8, further comprising a camera and a display unit, the memory further storing instructions which, when executed by the processing circuitry, cause the processing circuitry to:
obtain the image via the camera;
determine the luminance histogram of the image; and
display, via the display unit, the tone curve.

13. The apparatus of claim 8, the memory further storing instructions which, when executed by the processing circuitry, cause the processing circuitry to:
receive the image or the luminance histogram of the image from a remote device; and
transmit the tone curve to the remote device.

14. A non-transitory machine-readable medium storing instructions that, when executed by processing circuitry, cause the processing circuitry to:
obtain an image via an image sensor;
generate a luminance histogram of the image;
identify a target histogram for the image;
determine a first loss function based on a sum of a second loss function and a third loss function, the second loss function corresponding to a difference between the luminance histogram and the target histogram, the third loss function corresponding to a difference between a mean luminance of the image and a mean luminance target;
compute a gradient descent result by applying a gradient descent algorithm to the first loss function using a tuning constant based on image quality constraints and an exposure target; and
generate a tone curve comprising the computed gradient descent result.

15. The machine-readable medium of claim 14, further storing instructions that, when executed by the processing circuitry, cause the processing circuitry to:
determine the luminance histogram of the image using instructions that, when executed by the processing circuitry, cause the processing circuitry to:
determine luminance values for pixels of the image; and
determine the luminance histogram based on the luminance values.

16. The machine-readable medium of claim 15, wherein the luminance values are determined based on a greyscale version of the image.

17. The machine-readable medium of claim 14, wherein computing the gradient descent comprises minimizing the first loss function while maintaining preset constraints.

18. The machine-readable medium of claim 17, wherein the preset constraints comprise at least one of: avoiding noise enhancement above a noise enhancement threshold level, avoiding crushing black pixels above a black threshold level, or avoiding saturating or desaturating white pixels above a white threshold level.

19. The machine-readable medium of claim 14, further storing instructions that, when executed by the processing circuitry, cause the processing circuitry to:
determine the luminance histogram of the image; and
display the tone curve.

20. The machine-readable medium of claim 14, wherein the luminance histogram is obtained automatically in response to obtaining the image via an image sensor.
